(19) United States
(12) Patent Application Publication
(10) Pub. No.: US 2013/0139076 A1
(43) Pub. Date: May 30, 2013

(54) SCREEN SETTING FILE GENERATOR, GENERATION METHOD THEREOF, AND INFORMATION PROCESSING APPARATUS AND METHOD FOR DISPLAYING SCREEN USING SCREEN SETTING FILE

(71) Applicants: Arito Mochizuki, Tokyo (JP); Hikotatsu Chin, Tokyo (JP)

(72) Inventors: Arito Mochizuki, Tokyo (JP); Hikotatsu Chin, Tokyo (JP)

(73) Assignee: SONY COMPUTER ENTERTAINMENT INC., Tokyo (JP)

(21) Appl. No.: 13/611,245

(22) Filed: Sep. 12, 2012

(30) Foreign Application Priority Data
Nov. 28, 2011 (JP) 2011-259560

(51) Int. Cl. G06F 3/048

(52) U.S. Cl. 715/763

(57) ABSTRACT

A setting screen display unit in a user interface (UI) screen setting file generator displays a setting screen on which a user makes input for the setting of a UI screen. A setting information managing unit stores results of the arrangement of component images on the setting screen in an internal memory when a content creator has completed arranging the locations of the component images in a virtual screen region on the setting screen. A mode switching processing unit switches the setting screen according to a screen mode representing a mode to be set out of the mode variations that can be adopted by a display of a device executing content. A setting file generator generates a UI screen setting file, of a predetermined format, which contains setting information shared among a plurality of screen modes and setting information set individually for each display mode.

### BACKGROUND OF THE INVENTION

1. Field of the Invention

The present invention relates to a screen setting file generator for generating a file for setting a screen to be displayed in the execution or processing of content, an information processing apparatus for displaying a screen using the setting file, and a method for generating a screen setting file and a method for displaying a screen thereby.

2. Description of the Related Art

Recent years have seen widespread use of small information devices intended for mobile use, such as mobile game devices, mobile phones, PDAs (personal digital assistants), and tablets. These small devices have been subject to a limited variety of input means because of their size limitations. As a result, the input means and functions specialized in usage for such small devices have been undergoing a development on their own. For example, the facility for input with a finger or a stylus pen touching a touch panel on the display surface can now give the user a sense that he/she is directly operating an object displayed on a display.

On the other hand, the environment may be ready now for such small mobile devices to perform information processing equivalent to that performed by stationary game devices and personal computers. For example, users may today operate their small devices to have a stationary device connected thereto via a network perform actual information processing, with the result that the users can enjoy playing sophisticated games wherever they are. Also, games designed for stationary devices can now be played on small devices through emulation.

In recent years, therefore, the technological trend seems to be that game and other information processing can be executed irrespective of the size of the device or the environment of usage. However, lowered operability due to the above-mentioned limitations of input means has been a problem with the execution of such sophisticated information processing by use of small devices. Also, to provide enough screen size for especially small devices, use of graphical user interface (GUI) as the input means has been particularly effective in producing displays within the screen. Nevertheless, this has involved difficulty in making detailed settings for respective contents to be displayed or for respective modes of display.

### SUMMARY OF THE INVENTION

The present invention has been made in view of these problems, and a purpose thereof is to provide a technology capable of easily implementing a screen layout suited to the mode of display.

One embodiment of the present embodiment relates to a screen setting file generator. The screen setting file generator generates a screen setting file that sets a screen layout displayed on a display during execution of content, and the screen setting file generator includes: a setting screen display unit configured to display a setting screen including a virtual screen region representing a screen region of the display; an input unit configured to receive input from a user for setting information arranging component images in the virtual screen region; a mode switching processing unit configured to switch the setting screen in the setting screen display unit according to a plurality of modes of the display specified by the user; and a setting file generator configured to integrate the setting information in light of the plurality of modes of the display, configured to generate the screen setting file containing the setting information shared among the plurality of modes, and configured to output the generated screen setting file.

Another embodiment of the present invention relates to an information processing apparatus. The information processing apparatus executes content including setting information with which a screen layout displayed on a display is set, and the information processing apparatus includes: a screen mode identifying unit configured to identify a screen mode for a predetermined item of the display; and a screen generator configured to generate a screen by referencing both first setting information, which is set individually for the display mode identified by the screen mode identifying unit, and second setting information, which is shared among a plurality of display modes, and configured to display the generated screen on the display.

Still another embodiment of the present invention relates to a method for generating a screen setting file. The method for generating a screen stetting file is a method, for generating a screen setting file, employed by an apparatus that generates the screen setting file that sets a screen layout displayed on a display during execution of content, and the method includes: displaying a setting screen including a virtual screen region representing a screen region of the display; receiving input from a user via an input device for setting information arranging component images in the virtual screen region; switching the setting screen according to a plurality of modes of the display specified by the user; and integrating the setting information in light of the plurality of modes of the display, generating the screen setting file containing the setting information shared among the plurality of modes, and outputting the generated screen setting file to a storage device.

Still another embodiment of the present invention relates to a method for display a screen. The method for displaying a screen is a method, for displaying a screen, employed by a device that executes a content including setting information with which a screen layout displayed on a display is set, and the method includes: identifying a screen mode for a predetermined item of the display; and generating a screen by referencing both first setting information, which is set individually for the display mode identified by the identifying, and second setting information, which is shared among a plurality of display modes, and displaying the generated screen on the display.

Still another embodiment of the present invention relates to a data structure of a screen setting file. The data structure of a screen setting file is a data structure of a screen setting file that sets a screen layout displayed on a display during execution of content, and the data structure is such that individual setting information set respectively for a plurality of modes of the display are associated with common setting information shared among the plurality of modes and, in an apparatus for generating the screen setting file, the data structure is referenced to switch and display a setting screen including a virtual screen region representing a screen region of the display, according to the plurality of modes of the display specified by a user.

Optional combinations of the aforementioned constituting elements, and implementations of the invention in the form of methods, apparatuses, systems, recording media, computer programs, and so forth may also be practiced as additional modes of the present invention.

### BRIEF DESCRIPTION OF THE DRAWINGS

Embodiments will now be described by way of examples only, with reference to the accompanying drawings which are meant to be exemplary, not limiting, and wherein like elements are numbered alike in several Figures in which:

FIG. 1 shows a structure of a UI screen setting file generator according to an embodiment of the present invention;

FIG. 2 illustrates an example of a setting screen displayed on a setting screen display unit in an embodiment;

FIG. 3 illustrates an example of a setting screen, when the screen mode is switched to a vertically long screen, in an embodiment;

FIG. 4 shows an example of data on common setting information in an embodiment;

FIG. 5 shows an example of data on individual setting information in an embodiment;

FIG. 6 is a flowchart showing the content of a program when a UI screen setting file is generated as source code of the program, in an embodiment;

FIG. 7 is a flowchart showing a processing procedure for generating a UI screen setting file in an embodiment;

FIG. 8 shows a structure of an information processing apparatus that executes content including an UI screen setting file according to an embodiment; and

FIG. 9 is a flowchart showing a processing procedure for displaying an UI screen in an information processing apparatus according to an embodiment.

### DETAILED DESCRIPTION OF THE INVENTION

The invention will now be described by reference to the preferred embodiments. This does not intend to limit the scope of the present invention, but to exemplify the invention.

The preferred embodiments of the present invention relate to a technology for generating a UI (User Interface) screen to be displayed on a display during the execution or processing of content in an information processing apparatus and a technology for displaying the UI screen in the execution of content. The “content” as used herein is not limited to any specific types so long as the subject thereof, such as computer games, moving pictures, texts, photographs, and pictures, can be displayed on a display after electronic processing. Also, the embodiments of the invention can be applied not only to general “content” but also to the general information processing for the browsing of web pages, schedule management, display of an address list, document preparation, spreadsheet, and the like. In the following description, the information processing involving such image displays will be collectively referred to as the “execution of content”.

A UI screen is basically comprised of component images arranged in the background. The component images are, for instance, various graphical user interfaces (GUIs), such as buttons, scroll bars, check boxes and sliders, as well as labels showing characters, photographs, pictures, symbols, and the like. They are images displayed on a screen in association with the regions of the screen and can be either still images or moving images.

Designing UI screens optimally for these varied contents is very important from the viewpoint of operability and design quality. Yet, the diverse types of information processing apparatuses out in recent years have brought in a variety of display sizes and aspect ratios. Moreover, depending on the usage environment, the taste of the user, the type of content and other factors, the display may be viewed by the user with the display rectangle vertically long or horizontally long or at varying inclination angles of the screen plane. The embodiments of the present invention realize with ease these UI screen displays in precise correspondence to varied display environments.

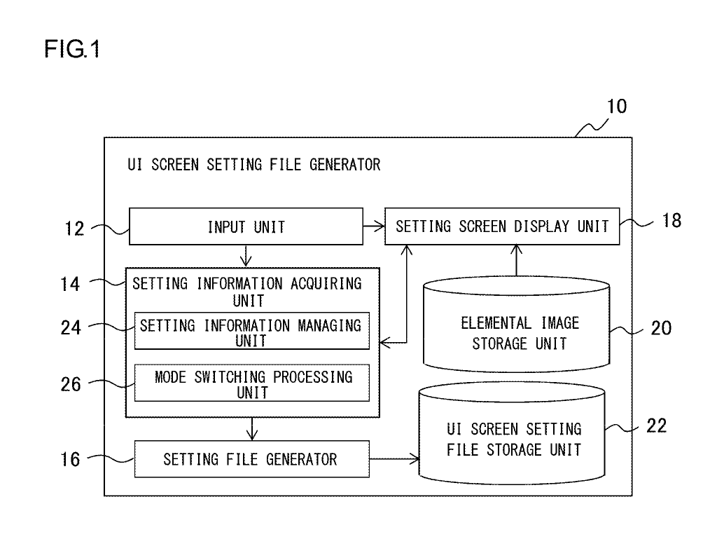

FIG. 1 shows a structure of a UI screen setting file generator. The UI screen setting file generator 10 generates a UI screen setting file by receiving the setting input for component images and their arrangement from a content creator. The UI screen setting file thus generated constitutes a content file together with programs and various data necessary for the execution of content. Note that such programs and data are prepared separately by use of commonly known technology.

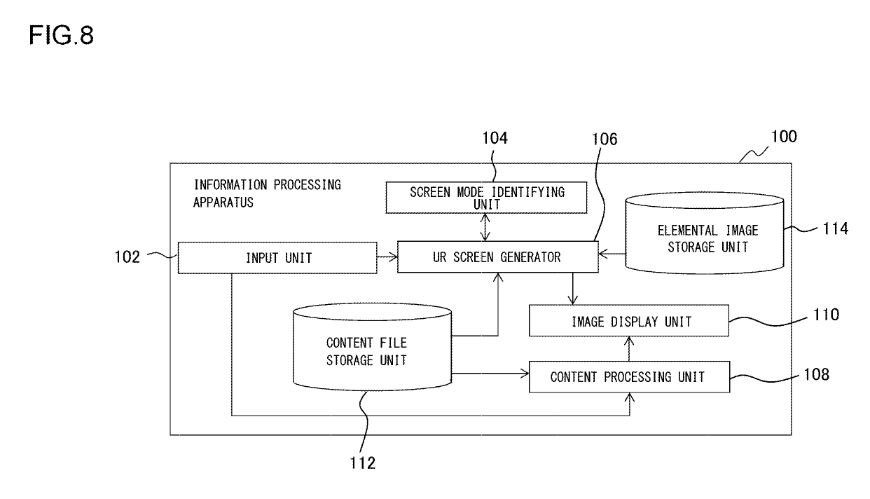

Each element shown in FIG. 1 and FIG. 8 (explained later) and described as a functional block for performing various processings may be implemented hardwarewise by a CPU, memory and other LSIs, and softwarewise by image processing programs or the like. Therefore, it is understood by those skilled in the art that the functional blocks may be implemented by a variety of manners including hardware only, software only or a combination of both, and are not limited to any particular one.

The UI screen setting file generator 10 includes an input unit 12, which is operated by a content creator for input of settings, a setting screen display unit 18, which displays a setting screen, a setting information acquiring unit 14, which acquires setting information, a setting file generator 16, which generates a UI screen setting file, an elemental image storage unit 20, which stores elemental (material) image data, and a UI screen setting file storage unit 22, which stores a UI screen setting file thus generated.

The input unit 12 is an interface through which the content creator performs input of settings while viewing the setting screen displayed by the setting screen display unit 18. The input unit 12 may be implemented by a general input device, such as a mouse, keyboard, pointing device, joy-stick, or touch panel. For the embodiments of the present invention, which employ an approach of arranging actual component images on a virtual UI screen, it is preferable that an input device with high affinity for such image operation is used.

The setting screen display unit 18 displays a setting screen on which the content creater makes input for the setting of a UI screen. The setting screen display unit 18 is constituted by a display for displaying the setting screen, a processor for generating and causing a display of component images whose arrangement, colors, and sizes have been changed according to the input of settings by the content creator through the input unit 12, and the like. Note that a technology commonly used by image drawing tools can be applied to the processing to generate images according to the input by the content creator.

Image data for basic shapes of graphics frequently used as component images are to be stored in advance in the elemental image storage unit 20. Hereinafter the images of such basic shapes will be referred to as “elemental images” or “material images”. With a list display of elemental images on the setting screen, the content creator can select desired elemental images, generate component images based on the selected elemental images, and arrange the thus generated component images within a virtual UI screen displayed on the setting screen. Note that the elemental images may be used directly as the component images.

The setting information acquiring unit 14 and the setting file generator 16 may be constituted by a processor and a memory or the like, for instance. The setting information acquiring unit 14 includes a setting information managing unit 24 and a mode switching processing unit 26. The setting information managing unit 24 stores confirmed results of the arrangement of component images on the setting screen in the internal memory when the content creator makes a confirmation input therefor. The mode switching processing unit 26 performs a control for the switching of the setting screen according to a mode to be set, by the user, out of the mode variations or parameters that can be adopted by the display of a device executing content. The mode variations or parameters that can be adopted by the display include the variations of screen size, the choice of vertically long or horizontally long screen, and the varying inclination angles of the display face from vertically up to vertically down.

Hereinafter, the mode of the display will be referred to as “screen mode”. It is not necessary that the screen modes represent all the above-mentioned modes of the display, but the screen modes may only represent two modes of horizontally long screen and vertically long screen, for instance. In the present embodiment, information set for a single content is described in a single UI screen setting file regardless of the number of screen modes. Accordingly, the setting information to be common to all screen modes, such as the color, shape and font of characters of component images, can be shared among the screen modes. At the same time, the setting information to be changed for different screen modes, such as arrangement and size of component images, can be set individually and thus independently. Hereinafter, the former information will be referred to as “common setting information”, and the latter information “individual setting information”.

At a request for the switching of the screen mode to be set by the content creator, the component images are displayed based on the setting done for the already set screen mode even when a new screen mode is requested. Also, the arrangement is such that if any modification of common setting information is made to a certain screen mode, then the modification must be reflected in all the screen modes. Upon completion of setting to all the screen modes by the content creator, the setting information managing unit 24 sends the setting information having been stored to the setting file generator 16. The information to be sent at this time is the common setting information and the information associating the individual setting information with the identification information on different screen modes.

The setting file generator 16 generates a UI screen setting file of a predetermined format based on the information sent from the setting information acquiring unit 14 and has the thus generated UI screen setting file stored in the UI screen setting file storage unit 22. Various formats for the UI screen setting file are conceivable depending on the way of reading the setting values, which is defined in a program of content stored together as the content file. For example, if a UI screen setting file itself is made part of the program of content as source code of the program, then it will not be necessary to newly read out individual setting files even when there is a change in the screen mode during the execution of content. This will result in a reduction of the burden of processing at the stage of execution. On the other hand, any of general setting files of markup language or tab delimited format may also be acceptable.

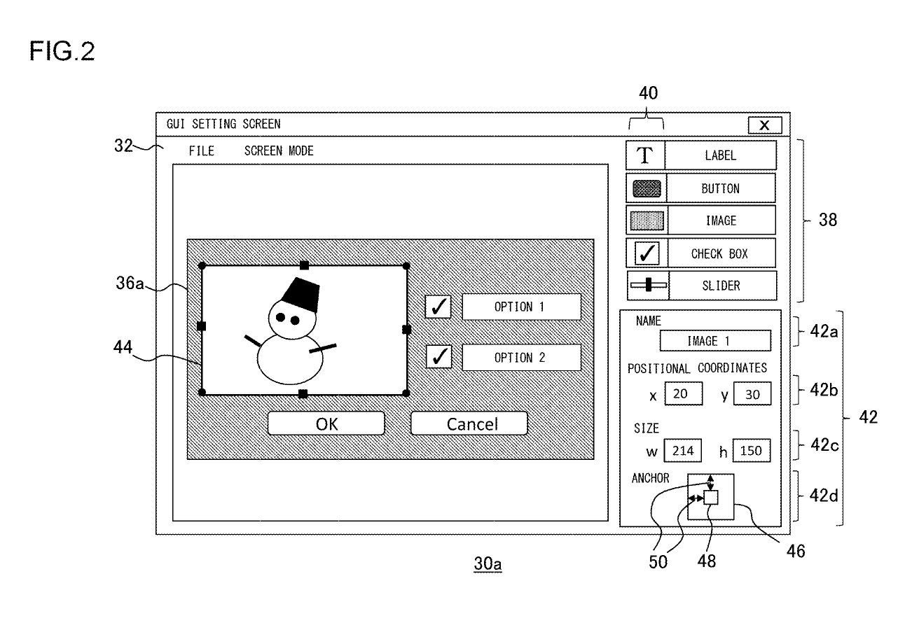

FIG. 2 illustrates an example of a setting screen displayed on the setting screen display unit 18. The example of a setting screen 30a displays a main menu 32, a canvas 36a, a materials (elements) list 38, and detail information 42. The main menu 32 includes a “file” menu and a “screen mode” menu. With the “file” menu selected, a pull-down menu of the name setting of a new setting file, the reading of an existing setting file, the storage of setting results, and the like is displayed. With the “screen mode” menu selected, a list of screen modes for the switching of the screen mode to be set or the like will be displayed.

The screen mode to be displayed here may, for instance, be a single screen mode freely combining the definitions of the parameters or conditions for the distinction between horizontally long screen and vertically long screen, the screen size, the inclination angle of the display face, and the like as mentioned above. Note that the numerical setting of each parameter may be done by the content creator. With one screen mode selected by the content creator from the list of screen modes, the setting screen display unit 18 displays the canvas 36a showing the region of a virtual UI screen corresponding to the selected screen mode. The region of the virtual UI screen is the region of an actual UI screen adjusted to a size that can be displayed in the setting screen. The setting information managing unit 24 generates setting information by converting the settings done for the virtual UI screen into the values on the actual UI screen using the scale factor.

The example of FIG. 2 represents a case where the setting is done in a screen mode for a horizontally long screen, and thus the canvas 36a, which is shaded, is also a horizontally long rectangle. The materials list 38 displays a list of elemental images stored in the elemental image storage unit 20. Shown in the example of FIG. 2 is a list of a “label” material representing a character label, a “button” material representing a GUI of a button, an “image” material representing a display region of separately prepared image data, a “check box” material representing a GUI of a check box, and a “slider” material representing a GUI of a slider. It should be noted that the list shown in FIG. 2 is only an example and is not intended to restrict the elemental images in any way.

The content creator arranges elemental images on the virtual UI screen by selecting symbols on the left side of the materials of the materials list 38 and associating the selected symbols with specific positions on the canvas 36a. This processing can be accomplished, for example, by selecting a symbol with a pointer and dragging the pointer to a desired position on the canvas 36a. On completion of this association of the symbols with specific positions on the canvas 36a, the corresponding elemental images are displayed at their respective positions in standard sizes and colors which have been set in advance. At this stage, the elemental images become the component images on the UI screen.

Then operations on the component images, such as expanding, shrinking, transforming, moving, and coloring, will be received on the canvas 36a. The actual operations and their procedures on the component images may be the same as those implemented by commonly-used image drawing tools. In FIG. 2, it is indicated by a thick frame that a component image 44 is the current object of operation. The detail information 42 shows the current detail information on a component image which is now the object of operation. In the example of FIG. 2, the detail information 42 shows a name 42a, positional coordinates 42b, size 42c, and anchor information 42d of the component image 44.

The name 42a of a component image, which is inputted by the content creator, is used to identify each component image in an UI screen setting file. The positional coordinates 42b show the positions of component images on the canvas 36a, for instance, the top left coordinates (x, y) of the component image, according to a predetermined rule. The size 42c shows the horizontal size (w) and vertical size (h) of the component image in predetermined units. These variables are changed relative to the operation on the component image on the canvas 36a. On the other hand, numerical values which are directly inputted by the content creator are reflected in the component image on the canvas 36a. The anchor information 42d shows graphically the rules defining how the position and the size of the component image are changed when an underlying image thereof changes in its size. The underlying image is, for instance, another component image on which the component image is superimposed, or the screen itself when the component image is not superimposed.

In the example of FIG. 2, the underlying image is represented by an external rectangle 46, and the image which is the object of operation is represented by an internal rectangle 48. And the places where the distance to be fixed in response to changes in the size of the underlying image are represented by arrows 50 as the anchors. In the case of FIG. 2, the rules set are such that the distance between the top edge of the underlying image and the top edge of the image to be operated upon and the distance between the left edge of the underlying image and the left edge of the image to be operated upon are fixed. Note that the marks to be displayed as anchor information 42d may be changed through predetermined operation to the input unit 12 by the content creator.

As for the rules that can be set, fixing the distance between the bottom ends or between the right ends of the images, either of the vertical length or the horizontal length of the image to be operated upon, or a combination of two or more of these parameters is conceivable in addition to the above. In the present embodiment, however, the UI screen can be set by switching a plurality of screen modes as described above. Therefore, with a content execution device compliant to any of the screen modes, it is not necessary to make an adjustment using anchor information for the actual screen at the stage of content execution.

The items to be displayed in the detail information 42, which can vary with the types of component images, namely elemental images, may be determined in advance for each elemental image. Then the items to be displayed in the detail information 42 may be switched according to the type of the component image to be operated upon. For example, in the case of “label” material, such items as the font and size of characters and the colors of characters and background may be further displayed, and the settings by the content creator may be accepted. The coloring item may be further added to the “button” material, the “check box” material, the “slider” material, and the like. In the case of the “image” material, the item for image data to be displayed in the region may be added, and the settings by the content creator may be accepted. In doing so, a screen to enable a search for image data to be referenced or the like may be displayed separately.

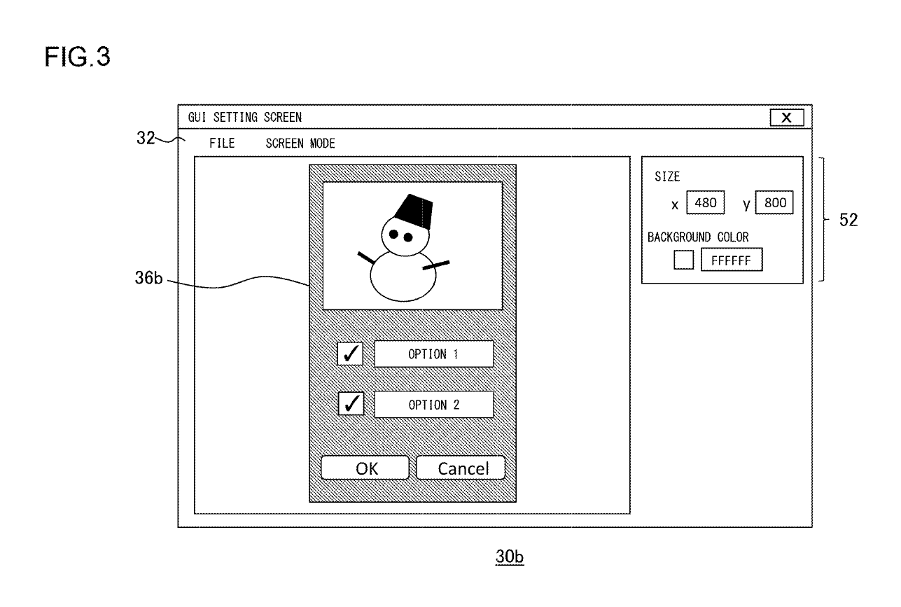

FIG. 3 illustrates an example of the setting screen when the screen mode is switched to the vertically long screen by the “screen mode” menu in the main menu 32 of FIG. 2. A canvas 36b in the example of a setting screen 30b shows a region corresponding to the vertically long screen. If a setting screen for the screen mode of the vertically long screen is newly displayed after the setting is done for the horizontally long screen as shown in FIG. 2, the component images set for the horizontally long screen are arranged on the canvas 36b.

That is, the component images generated in the horizontally long screen are also available and usable for the vertically long screen as well. However, the mode switching processing unit 26 makes an adjustment according to a predetermined rule such that the sizes of the component images and the arrangement thereof can be fit into the vertically long screen. For example, the component images suitable for the horizontally long screen are extracted from the top left of the screen in a raster direction and are arranged from the top left of the canvas 36b of the vertically long screen in the order of extraction. If any of the component images has the width unfit to the horizontal width of the vertically long screen, it will be scaled down.

The above example illustrates a case where the settings for the horizontally long screen is used for the vertically long screen. Conversely, the settings for the vertically long screen can also be used for the horizontally long screen or a screen having a different aspect ratio. Also, the size and the arrangement may be adjusted based on the anchor information set in each component image.

In any of the above cases or even in the case of handling a new screen mode, too, the settings for other screen modes can be still used and therefore most of UI screens can be prepared by the apparatus itself. This eliminates the need for the content creator to set the whole thing again from the beginning, thereby significantly reducing the work burden. The content creator can freely adjust the size and the arrangement of the component images that have already been displayed on the canvas 36b. The example of the setting screen 30b further displays detail information 52 on the canvas 36b.

The detail information 52 displays the detail information concerning the newly displayed canvas 36b, more specifically, the size and the background color thereof. These items of detail information are also reflected in the canvas 36b when the numerical values are directly inputted by the content creator. If the content creator selects any of the component images displayed on the canvas 36b as an object of operation, the detail information on said component images will be displayed as shown in the detail information 42 of FIG. 2. In this manner, the content creator adjusts each component image by directly operating the component image shown in the canvas 36b or entering the numerical value into the detail information.

As described above, the setting information managing unit 24 stores the settings done for a plurality of image modes in association with the screen modes. When the content creator instructs the saving of a file through a “file” menu in the main menu 32, the setting file generator 16 obtains all of setting information so as to generate a UI screen setting file. As already mentioned, the setting information contains the common setting information and the individual setting information.

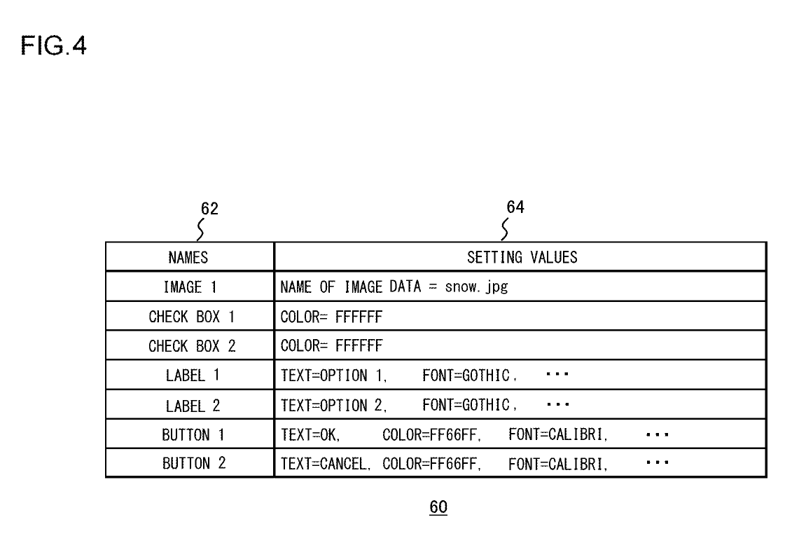

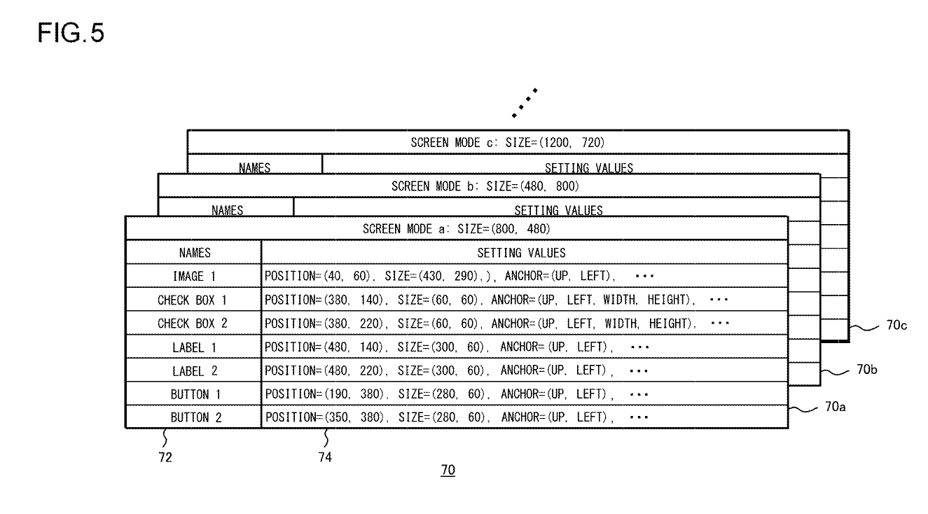

FIG. 4 shows an example of data on common setting information. It is to be noted that the data shown in FIG. 4 and FIG. 5 are only examples of the kinds of information and therefore place no limitation on the format of the UI screen setting file. The common setting information 60 holds setting information shared by screen modes, which is listed in a setting value field 64 in association with the names of component images listed in a name field 62.

Each of the names of component images listed in the name field 62 is the name inputted by the content creater as the name 42a in the detail information 42 of FIG. 2. Alternatively, those names may be each a combination of the name of an original elemental image and the identification number automatically given by the apparatus. If the name of an elemental image is incorporated into the name of a component image, then the device executing content can identify the data on the elemental image and use the identified data to generate and display the component image at the stage of content execution. The identification information of component images and the identification information of elemental images are associated with each other separately.

Note that the setting information of FIG. 4 corresponds to the component image shown in FIGS. 2 and 3. Corresponding to the component image “Image 1” using the “image” material (element), the image data “snow.jpg” is set for the image to be displayed in the assigned region. The setting for the color of both the component images “Check Box 1” and “Check Box 2” using the “check box” material is “FFFFFF”.

Corresponding to the component images “Label 1” and “Label 2” using the “label” material, the character information “Option 1” and “Option 2” are respectively set as the characters to be displayed, and the font “Gothic” is set for both. Corresponding to the “Button 1” and “Button 2” component images using the “button” material, the character information “OK” and “Cancel” are respectively set as the characters to be displayed, the button color “FF66FF” and the font “Calibri” are set for both.

FIG. 5 shows an example of data on individual setting information. The individual setting information 70 is so structured that a plurality of setting information 70a, 70b, 70c, . . . , each having the same constitution, are associated with a plurality of screen modes a, b, c, . . . . Note that if there is only one screen mode, there is naturally only one set of setting information. In the example of FIG. 5, each screen mode is defined by the horizontal size and vertical size. That is, as indicated at the top of the setting information of each screen mode, the screen size for screen mode a is (800, 480), the screen size for screen mode b is (480, 800), and the screen size for screen mode c is (1200, 720).

Defining a screen mode by the size in each direction will permit simultaneous setting of the size of the screen, the distinction between the horizontally long screen and the vertically long screen, and the aspect ratio. As already mentioned, when, for example, the setting is changed with the inclination angle of the display face despite the same size, the screen mode may be subdivided by use of other attributes.

The setting information 70a, 70b, 70c, . . . for the respective screen modes have each the same structure as the common setting information 60 as shown in FIG. 4 except for the setting items in a settings field 74 that are different. Therefore, the names of component images in the name field 72 are the same as those listed in the name field 62 of the common setting information 60. And the setting information 70 holds information to be set individually of each screen mode concerning the respective component images, that is, the positional coordinates, sizes, and anchor information in the case of the example shown in FIG. 5.

For example, in the setting information 70a, the positional coordinates of the component image “Image 1” is “(40, 60)”, the size thereof is “(430, 290)”, and the anchor thereof is (up, left) which means that the distances between “Image 1” and the underlying image in their upper sides and left sides are fixed. Similarly, for the other component images, the names of the component images are associated with the positional coordinates, the size and the anchor information set by the content creator.

The setting file generator 16 generates the UI screen setting file in a format such that the common setting information as shown in FIG. 4 can be referenced regardless of the screen modes, and the individual setting information as shown in FIG. 5 can be referenced according to the screen modes. For example, if, as described above, the UI screen setting file is generated as source code of the program, a program for checking the screen mode for the latter and branching off a process according to the checking result is generated. For the former, the process is not branched off. Then it is outputted as a single source code.

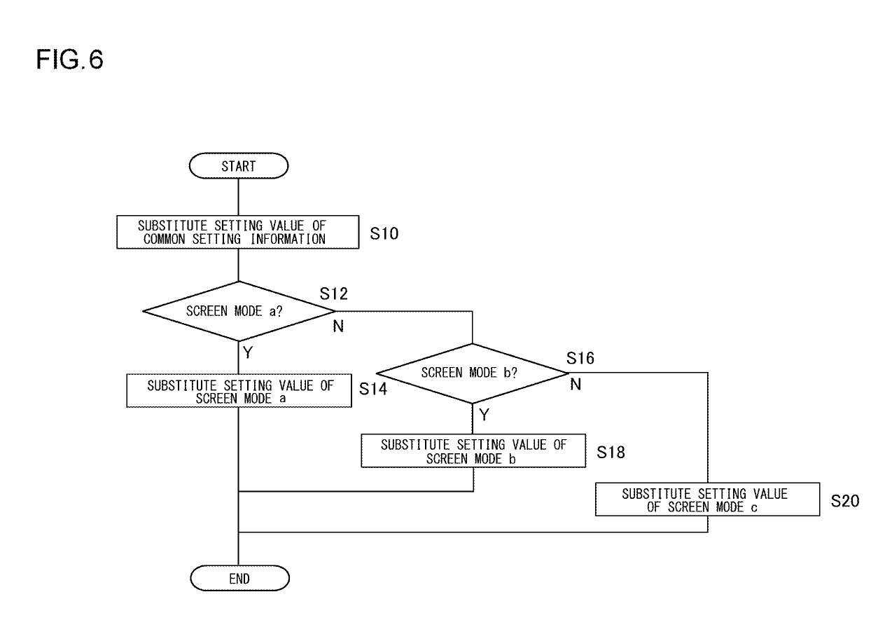

FIG. 6 is a flowchart of a program when an UI screen setting file is generated as a source code of the program. This example shows a case where the settings are made for the screen modes a, b, and c shown in FIG. 5. Note that the program for generating the UI screen using the elemental image data is prepared separately and the program of FIG. 6 describes a process where the setting values are substituted into variables used in the program for generating the UI screen.

The setting value of each item set to the common setting information is first substituted (S10). Then, if it is determined through the process for checking the screen mode that the actual screen is of the screen mode a (Y of S12), the setting value of each item set to the setting information 70a of the screen mode a will be substituted (S14). If it is determined that the actual screen mode is of the screen mode b (N of S12, Y of S16), the setting value set to the setting information 70b of the screen mode b will be substituted (S18). Otherwise, namely if it is determined that the actual screen mode is of the screen mode c (N of S12, N of S16), the setting value set to the setting information 70c of the screen mode c will be substituted (S20).

Thereby, in the device executing content, the setting value used to generate the UI screen is always switched to the optimum value for the screen mode of the device. Decision is made beforehand as to which items are to be the common setting information or to be the individual setting information among the setting items. It is to be noted here that the decision may be made by the content creator, namely the content creator may specify them. However, for items that must be changed depending on the screen modes, such items as these will naturally be sorted out as the individual setting information. For example, when the setting is changed from the horizontally long screen as shown in FIG. 2 to the vertically long screen as shown in FIG. 3, the items that have been automatically adjusted, namely the size and the arrangement, are the individual setting information. As a result, once the setting of an item belonging to the common setting information is changed on one screen mode, the change can be reflected in all the screen modes.

In another embodiment, an item which is to be categorized as the individual setting information may be changed according to a setting process. For example, the settings done in an initial screen mode are all categorized as the common setting information, and items which are changed in another screen mode may be later shifted to the individual setting information as needed. In such a case, the individual setting information will be generated for the previous screen modes, too. This processing is equivalent to, for example, a process where in the program shown in FIG. 6 the description concerning the items is deleted from the process of substituting the setting values of the common setting information in Step S10 and then added respectively to the processes of substituting the setting values of the screen modes of Steps S14, S18 and S20.

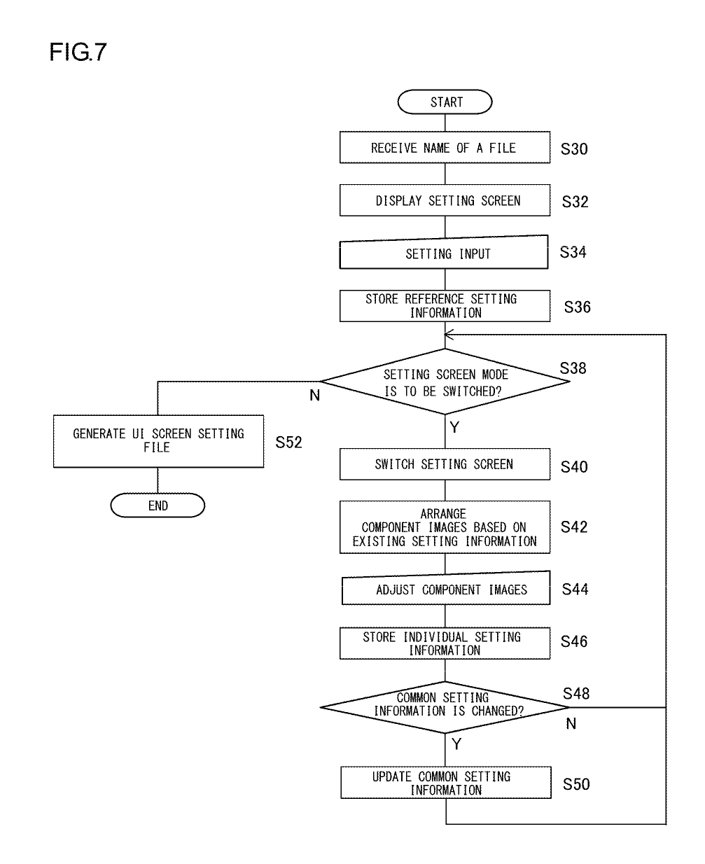

A description is now given of an operation of the UI screen setting file generator 10 achieved by the above-described structure. FIG. 7 is a flowchart showing a processing procedure, performed by the UI setting file generator 10, for receiving the setting input of the content creator and generating a UI screen setting file. As the content creator first inputs via the input unit 12 an instruction to start a setting work by specifying the name of a setting file and the like, the setting information managing unit 24 of the setting file acquiring unit 14 prepares a new file having said file name (S30). If an existing file is specified, it will be read out.

Then the setting screen display unit 18 displays a setting screen as shown in FIG. 2 (S32). When, at this time, the content creator inputs the screen size, the setting screen display unit 18 displays the region of a virtual UI screen, corresponding to the thus inputted screen size, as the canvas. One screen mode is defined by this screen size. If, however, the existing setting file is read out in the Step S30, any one of screen modes set to the read-out file will be selected and the already-set UI screen will be displayed.

Then the content creator performs, via the input unit 12, the setting inputs, such as the adjustment of the arrangement and size of component images and the setting of colors and fonts, to the setting screen (S34). As the content creator makes a confirmation input for the settings, the setting information managing unit 24 stores the thus set information together with the name specified in Step S30 and identification information of a screen mode such as the screen size (S36). At this time, the common setting information and the individual setting information are distinguished from each other. The content creator may specify the name or the like of the screen mode as the identification information of a screen mode. If a UI screen setting file is to be newly created, the setting information stored in the Step S36 will be the basis of and used for the setting screen for later-set screen mode.

Then, as the content creator enters his/her instruction to switch the screen mode (Y of S38), the setting screen display unit 18 switches the size of the canvas so that the size thereof corresponds to the screen size entered newly by the content creator (S40). Then the mode switching processing unit 26 of the setting file acquiring unit 14 determines the arrangement of locations of the respective components after the switching, based on the previously used setting information and causes the display by the setting screen display unit 18 (S42).

More specifically, if the setting has been made to the same screen mode in the past in the same setting file, the component images will be arranged based on the information in the past. If, on the other hand, a new setting is made to said screen mode, the component images will be arranged based on reference setting information that the setting information managing unit 24 has stored in Step S36. If the component images are arranged based on the reference setting information, the component images will be rearranged and/or the size thereof will be changed, as need arises, as discussed above.

The content creator adjusts the component images, as appropriate, on the thus displayed setting screen (S44). As the content creator makes a confirmation input for the settings, the setting information managing unit 24 stores the thus set individual setting information together with the screen mode identification information of the screen mode after the switching (S46). If the setting value(s) of any of items in the common setting information has/have been changed (S48), the common setting information in the setting information stored in Step S36 will be updated (S50).

As the content creator enters his/her instruction to switch the screen mode to another screen mode (Y of S38), the processes performed in Steps S40 to S50 will be repeated. Then, as the content creator enters his/her instructions to terminate the settings for the all the screen modes and to generate a UI screen setting file (N of S38), the setting file generator 16 will generate a final UI setting file having a name specified in Step S30 (S52).

A description is now given of a structure with which to run content incorporating the UI screen setting file generated by the above-described method. FIG. 8 shows a structure of the information processing apparatus that executes the content including the UI screen setting file generated according to the present embodiment.

The information processing apparatus 100 includes a content file storage 112 for storing content files including a UI screen setting file, an input unit 102 for receiving input concerning the execution of content from the user, a screen mode identifying unit 104 for identifying a screen mode of the information processing apparatus 100, an elemental image storage unit 114 for storing elemental (material) image data, a UI screen generator 106 for generating a UI screen based on the screen mode and the UI screen setting file, a content processing unit 108 for executing other processes related to the content, and an image display unit 110 for rendering an image to be displayed and then displaying the rendered image.

The input unit 102 is an interface through which the user performs various inputs necessary for the execution of content such as input of an instruction to start or terminate the execution of content and an operation of GUI on the UI screen displayed. The input unit 12 may be implemented by a general input device, such as a touch panel, pointing device, keyboard or joy-stick.

The screen mode identifying unit 104, the UI screen generator 106 and the content processing unit 108 are each constituted by a processor and a memory. The screen mode identifying unit 104 identifies the screen mode of the information processing apparatus 100. For example, the screen mode identifying unit 104 reads out the information, on the size of the screen, which is stored in advance in the information processing apparatus 100. Alternatively, the distinction between horizontally long screen and vertically long screen, the inclination angle of the display face, and the like may be acquired from the output values of an acceleration sensor or a gyro sensor mounted within the information processing apparatus 100.

Based on these items of information, the screen mode identifying unit 104 selects one screen mode from among the screen modes defined by the UI screen setting file. The processing for identifying the screen mode is not only performed in response to the request from the UI screen generator 106 in order to generate the UI screen at the start of execution of content, but also performed at predetermined time intervals. This can display the UI screen which is constantly most suitable in response to the changing conditions of how the information processing apparatus is held by the user and his/her posture or position.

The UI screen generator 106 generates the UI screen in such a manner that component images are generated and arranged by using the data of elemental images read out from the elemental image storage unit 114 based on the UI screen setting file stored in the content file storage 112. Note that the UI screen setting file in the content file storage 112 may be such that the source code of a program generated by the UI screen setting file generator 10 is being compiled together with other programs. In this case, the UI screen image generator 106 substitutes the setting values into variable, used to generate the UI screen, by performing the procedure of FIG. 6 and then performs a UI screen generation processing. A commonly used technology can be applied to the screen generation processing itself.

If the mode of the display, namely screen mode, does not match any of the screen modes defined in the UI screen setting file, the screen mode identifying unit 104 will convey this fact to the UI screen generator 106 and then the UI screen generator 106 will generate a UI screen using any of the setting information of the screen mode defined. For example, a screen mode closest to the mode of display is selected or a screen mode serving as a reference is determined beforehand. Then the UI screen generator 106 arranges the component images based on the anchor information etc. which are set in the setting information therefor. As explained in connection with FIG. 3, the adjustment similar to that made when the screen mode is switched to the new screen mode on the setting screen.

The content processing unit 108 reads out a program of content and various data stored in the content file storage 112 and performs arithmetic processing, as appropriate, according to a user's operation. The image display unit 110, which is constituted by a processor for rendering images, a display, and the like, renders and displays the images in response to requests sent from the UI screen generator 106 and the content processing unit 108.

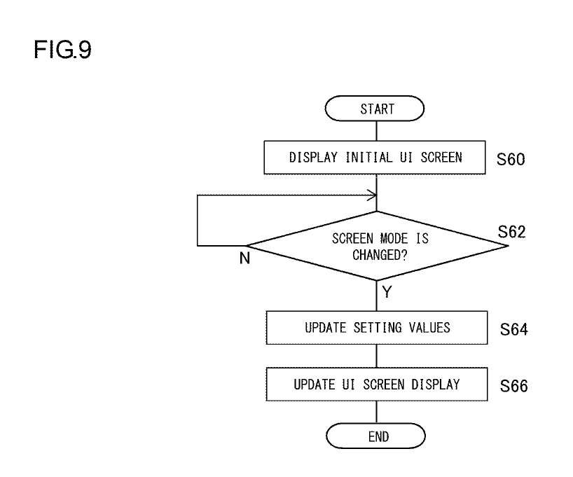

A description is now given of an operation of the information processing apparatus 100 achieved by the above-described structure. FIG. 9 is a flowchart showing a processing procedure for displaying a UI screen in the information processing apparatus 100. As the user first enters his/her instruction to start the execution of content via the input unit 102 by selecting content or the like, the UI screen generator 106 has the screen mode identifying unit 104 identify the screen mode at that time and then generates the UI screen according to the identified result and the information on the UI screen setting file. Then the image display unit 110 displays the thus generated UI screen as an initial UI screen.

Though the content processing unit 108 may operate, as appropriate, based on the operation on the initial UI screen executed by the user or the like, the description related to this process is omitted in FIG. 9. Also, the UI screen generator 106 may change the color of a GUI, make the operation seem to be actually pressing a button of a GUI, display various animations or the like, according to user's operation on the currently displayed GUI, but a commonly-used technology may be employed to realizes these and therefore they are omitted in FIG. 9.

If no change in the screen mode is detected by the screen mode identifying unit 104 during a display, the on-going mode will be maintained (N of S62). If a change in the screen mode is detected thereby (Y of S62), the UI screen generator 106 will execute again, for example, only a branching decision process from the Step 12 in the procedure shown in FIG. 6 so as to update the setting values used for the generation of the UI screen (S64). Then the UI screen is generated using the updated values and displayed on the image display unit 110, thereby updating the display of the UI screen (S66).

By employing the above-described embodiments, the setting can be made by switching a plurality of screen modes that have varied the modes of the display such as the screen size, the choice of vertically long or horizontally long screen, and the inclination angles of the display face at the time of setting the UI screen constituted by the component images. At this time, the setting information on predetermined items such as the color, shape and font is shared among all the screen modes. As a result, the flexible setting can be made for the items desired to change depending on the screen modes and, at the same time, a change made to a screen mode will be reflected in the rest of the screen modes regarding the items commonly set.

If the user wishes to decide on a design by repeating a fine adjustment of color or shape, for example, and seeing how the fine adjustment works, the result of the fine adjustment can be easily checked in all the screen modes and the work efficiency can be markedly improved. At the same time, more detailed setting can be done for each screen mode, than in the case where set are fixed rules for the variation in the screen size such that the distance from the screen is fixed, or the size of each component image is determined so that it changes proportionally to the screen size.

A virtual UI image region according to the screen mode is displayed on a screen for accepting the settings, and the component images are created and arranged on the virtual UI image region like drawing an image. Even when this screen is a screen for a new screen mode, an approximate UI image is prepared by the apparatus itself by use of the setting information of other screen modes. This eliminates the need for the content creator to recreate the component images from the beginning for each screen mode and therefore the work burden for the setting work can be significantly reduced especially when a large number of screen modes are to be defined, for example.

The setting information on a plurality of screen modes is outputted as an identical file. Hence, even if the number of screen modes increases, the number of files will not increase, thus achieving a setting file compatible with various types of apparatuses and screen modes. Further, even if the screen mode changes during a display and during the execution of content, only a setting value(s) to be updated can be updated, so that the processing efficiency in displaying the UI screen can be improved.

The present invention has been described based upon illustrative embodiments. The above-described embodiments are intended to be illustrative only and it will be obvious to those skilled in the art that various modifications to the combination of constituting elements and processes could be developed and that such modifications are also within the scope of the present invention.

What is claimed is:

1. A screen setting file generator for generating a screen setting file that sets a screen layout displayed on a display during execution of content, the screen setting file generator comprising:
a setting screen display unit configured to display a setting screen including a virtual screen region representing a screen region of the display;
an input unit configured to receive input from a user for setting information arranging component images in the virtual screen region;
a mode switching processing unit configured to switch the setting screen in the setting screen display unit according to a plurality of modes of the display specified by the user; and
a setting file generator configured to integrate the setting information in light of the plurality of modes of the display, configured to generate the screen setting file containing the setting information shared among the plurality of modes, and configured to output the generated screen setting file.

2. The screen setting file generator according to claim 1, wherein the mode switching processing unit displays, on the setting screen for a new mode of the display, the virtual screen region where component images are arranged based on the setting information on an already-set mode.

3. The screen setting file generator according to claim 1, further comprising a setting information managing unit configured to update the setting information,
wherein, when input to update the setting information shared among the plurality of modes is entered to a setting screen in a single mode, the setting information managing unit updates the setting information such that the updating done to the setting screen in the single mode affects the setting screens for the other remaining plurality of modes of the display.

4. The screen setting file generator according to claim 1, wherein the mode switching processing unit switches the setting screen according to the plurality of modes of the display as specified by the user, the setting screen being set out of a combination of one or at least two parameters comprised of a screen size of the display, a choice of vertically long or horizontally long screen, and an inclination angle of a display face.

5. The screen setting file generator according to claim 1, wherein the setting file generator generates the screen setting file as source code of a program that loads setting values for the setting information, and
wherein the program includes a process where the loading of an item not contained in the setting information shared among the plurality of modes is branched off depending on a mode of the display.

6. The screen setting file generator according to claim 1, further comprising a setting information managing unit configured to exclude a setting item from the setting information shared among the plurality of modes, and configured to count said excluded setting item as setting information that is set individually for the display mode,
wherein the excluded setting item is such that a setting different from the setting done for the other remaining plurality of modes of the display than a single mode is made to a setting screen in said single mode.

7. An information processing apparatus for executing content including setting information with which a screen layout displayed on a display is set, the information processing apparatus comprising:
a screen mode identifying unit configured to identify a screen mode for a predetermined item of the display; and
a screen generator configured to generate a screen by referencing both first setting information, which is set individually for the display mode identified by the screen mode identifying unit, and second setting information, which is shared among a plurality of display modes, and configured to display the generated screen on the display.

8. The screen setting file generator according to claim 7, wherein the screen mode identifying unit verifies the screen mode for the predetermined item of the display at predetermined time intervals, and
wherein, when the screen mode changes, the screen generator updates a current display screen by referencing again only the first setting information for a mode after a change.

9. A method, for generating a screen setting file, employed by an apparatus that generates the screen setting file that sets a screen layout displayed on a display during execution of content, the method comprising:
displaying a setting screen including a virtual screen region representing a screen region of the display;
receiving input from a user via an input device for setting information arranging component images in the virtual screen region;
switching the setting screen according to a plurality of modes of the display specified by the user; and
integrating the setting information in light of the plurality of modes of the display, generating the screen setting file containing the setting information shared among the plurality of modes, and outputting the generated screen setting file to a storage device.

10. A method, for displaying a screen, employed by a device that executes content including setting information with which a screen layout displayed on a display is set, the method comprising:
identifying a mode for a predetermined item of the display; and
generating a screen by referencing both first setting information, which is set individually for the identified display mode, and second setting information, which is shared among a plurality of display modes, and displaying the generated screen on the display.

11. A program, embedded in a non-transitory computer-readable medium, for generating a screen setting file that sets a screen layout displayed on a display during execution of content, the program comprising:
a setting screen display module operative to display a setting screen including a virtual screen region representing a screen region of the display;
an input module operative to receive input from a user via an input device for setting information arranging component images in the virtual screen region;
a mode switching processing module operative to switch the setting screen according to a plurality of modes of the display specified by the user; and
a setting file generating module operative to integrate the setting information in light of the plurality of modes of the display, operative to generate the screen setting file containing the setting information shared among the plurality of modes, and operative to output the generated screen setting file to a storage device.

12. A program, embedded in a non-transitory computer-readable medium, for executing content including setting information with which a screen layout displayed on a display is set, the program comprising:
a screen mode identifying module operative to identify a screen mode for a predetermined item of the display; and
a screen generating module operative to generate a screen by referencing both first setting information, which is set individually for the display mode identified by the screen mode identifying module, and second setting information, which is shared among a plurality of display modes, and operative to display the generated screen on the display.

13. A non-transitory computer-readable medium encoded with a computer program, executable by a computer, for generating a screen setting file that sets a screen layout displayed on a display during execution of content, the computer program comprising:
a setting screen display module operative to display a setting screen including a virtual screen region representing a screen region of the display;
an input module operative to receive input from a user via an input device for setting information arranging component images in the virtual screen region;
a mode switching processing module operative to switch the setting screen according to a plurality of modes of the display specified by the user; and
a setting file generating module operative to integrate the setting information in light of the plurality of modes of the display, operative to generate the screen setting file containing the setting information shared among the plurality of modes, and operative to output the generated screen setting file to a storage device.

14. A non-transitory computer-readable medium encoded with a computer program, executable by a computer, for executing content including setting information with which a screen layout displayed on a display is set, the computer program comprising:
a screen mode identifying module operative to identify a screen mode for a predetermined item of the display; and
a screen generating module operative to generate a screen by referencing both first setting information, which is set individually for the display mode identified by the screen mode identifying module, and second setting information, which is shared among a plurality of display modes, and operative to display the generated screen on the display.

15. A non-transitory computer-readable medium recording a data structure of a screen setting file that sets a screen layout displayed on a display during execution of content, wherein individual setting information set, respectively, for a plurality of modes of the display are associated with common setting information shared among the plurality of modes, and
wherein, in an apparatus for generating the screen setting file, the data structure is referenced to switch and display a setting screen including a virtual screen region representing a screen region of the display, according to the plurality of modes of the display specified by a user.
